(19) United States
(12) Patent Application Publication
(10) Pub. No.: US 2006/0250407 A1
(43) Pub. Date: Nov. 9, 2006

(54) Texture filtering using a programmable table filter to improve computer graphics performmance

(75) Inventor: Jiangming Xu, San Jose, CA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies, Inc.

(21) Appl. No.: 11/122,724

(22) Filed: May 5, 2005

(51) Int. Cl. G09G 5/00

(52) U.S. Cl. 345/582

(57) ABSTRACT

Provided are methods, systems and graphics processing apparatus, for improving graphics system performance using an adaptive texture coefficient table filter for texture filtering. The texture filter is programmed with various texture coefficients for advanced texture filtering operations.

### TECHNICAL FIELD

The present disclosure is generally related to texture filters, and, more particularly, is related to texture filters using a programmable table filter to improve texture filter performance in a computer graphics environment.

### BACKGROUND

As is known, computer graphics processing systems process large amounts of data, including texture data, among others. A texture is a digital image, often rectangular, having a (U, V) coordinate space. The digital image can also be expressed in three-dimensions having a (U, V, S) coordinate space. The smallest addressable unit of a texture is a texel, which is assigned a specific (U, V) coordinate based on its location. Texture mapping is a well-known technique of projecting a texture onto a surface in a graphics system. Typical applications of the technique involve reading texture data (texels) of a two-dimensional texture that represents a digitized image, and mapping the texture data onto a surface that is defined in three-dimensional space. The surface, when rendered and projected onto a two-dimensional display, is imbued with greater realism as it appears to contain the surface characteristics defined in the texture map. In a texture-mapping operation, a texture is mapped to the surface of a graphical model as the model is rendered to create a destination image. In the destination image, pixels are located at specific coordinates in the (X, Y) coordinate system in two-dimensional space or the (X, Y, Z) coordinate system in three-dimensional space.

Prior art approaches to texture filtering typically determine color coefficients for a pixel by storing several versions of a particular texture map, at varying levels of detail. Usually, these levels are defined by powers of two, for example, a 2×2 square containing four texels corresponding to one texel at the next higher level of detail is filtered (averaged) to produce the next upper level texel. In the limit, the entire texture map may be reduced to one texel at the lowest level of detail. In some cases, however, certain special graphics effects require greater operational flexibility and result in unwanted inefficiency and performance when generated using known texture filter components such as linear interpolators and accumulators. Thus, a heretofore-unaddressed need exists in the industry to address the aforementioned deficiencies and inadequacies.

### SUMMARY

Embodiments of the present disclosure may be viewed as providing a method of filtering computer graphics texture data, comprising: programming a table with texture filter data; assigning a plurality of table identification values; determining a filter kernel, configured as a texel array including a plurality of texels, corresponding to a location of a pixel; calculating a plurality of weight factors from a portion of the texture data, corresponding to the filter kernel; and modifying a pixel color value, corresponding to the pixel, using the plurality of weight factors.

Briefly described, in architecture, one embodiment, among others, can be implemented as a computer graphics processing apparatus comprising: kernel logic configured to define a plurality of texels having a plurality of kernel dimensional characteristics; register logic configured to store a plurality of coefficients for a kernel; identification logic configured to assign a table identification value to the kernel; conversion logic configured to generate a plurality of blend factors; interpolation logic configured to receive a portion of the plurality of blend factors; and accumulation logic configured to receive a portion of the plurality of blend factors.

An embodiment of the present disclosure can also be viewed as providing a system for filtering computer graphics data, comprising: a data storage buffer adapted to store multiple sample anti-aliasing color data; calculation logic configured to determine a plurality of weight values for the multiple sample anti-aliasing color data; and a programmable table filter configured to store the plurality of weight values.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates a simplified block diagram of a computer system.

FIG. 2 is a block diagram illustrating an exemplary system for performing texture filtering operations of the present disclosure.

FIG. 3 illustrates certain basic components of an embodiment of a computer graphics system.

FIG. 4 is a block diagram illustrating an embodiment of a computer graphics device as disclosed herein.

FIG. 5 is a diagram of an exemplary embodiment of a general two-dimensional convolution programmable table filter kernel.

FIG. 6 is a block diagram illustrating an embodiment of the application of table filter values to texture filter components, as discussed above in reference to FIG. 5.

FIG. 7 is a diagram of an exemplary embodiment of a separable two-dimensional convolution programmable table filter kernel.

FIG. 8 is a block diagram illustrating an embodiment of the application of separable table filter values to texture filter components, as discussed above in reference to FIG. 7.

FIG. 9 is a block diagram illustrating a table filter kernel configured for multi-sample anti-aliasing (MSAA) down filtering.

FIG. 10 is a block diagram illustrating the actual storage configuration of the MSAA down-sampling filter referenced in FIG. 9.

FIG. 11 is a block diagram illustrating an embodiment of a method of filtering texture data using a programmable table filter, as disclosed herein.

### DETAILED DESCRIPTION

Having summarized various aspects of the present disclosure, reference will now be made in detail to the description of the disclosure as illustrated in the drawings. While the disclosure will be described in connection with these drawings, there is no intent to limit it to the embodiment or embodiments disclosed therein. On the contrary, the intent is to cover all alternatives, modifications and equivalents included within the spirit and scope of the disclosure as defined by the appended claims.

As will be described further herein, there are several locations in a graphics system where features or aspects of the disclosure may be implemented. Likewise, it will be appreciated from the description herein that there are systems and environments in fields other than computer graphics where the concepts of the disclosure may be employed as well.

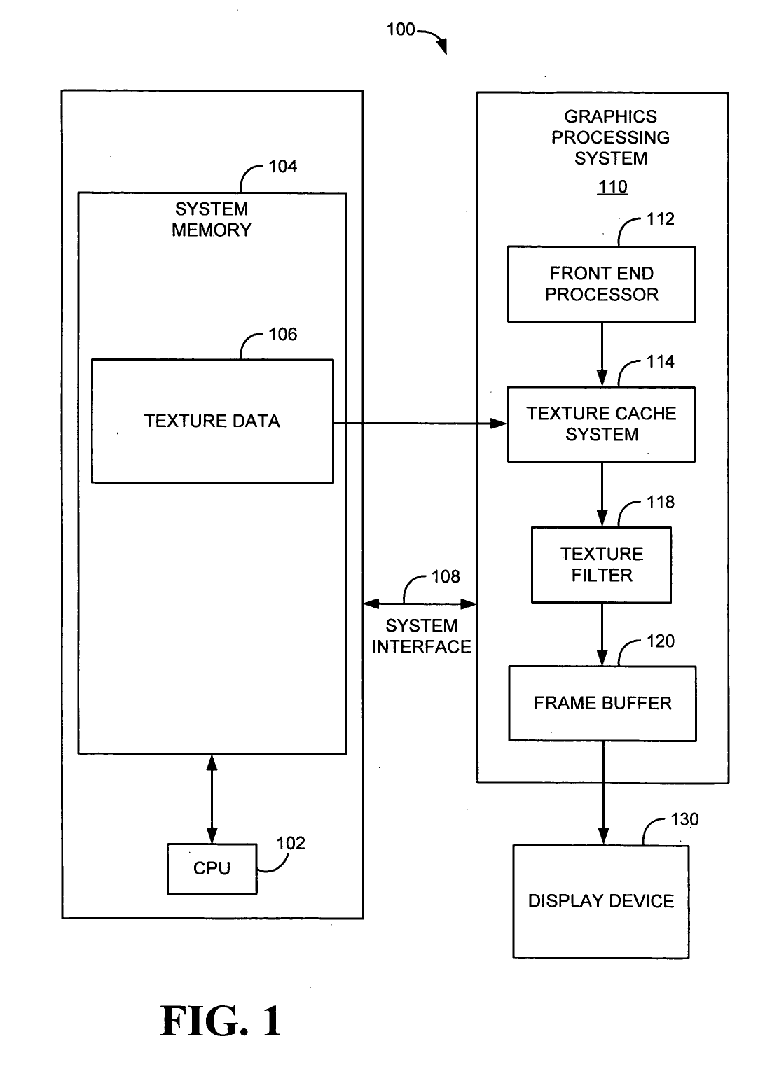

Reference is made to FIG. 1, which illustrates a simplified block diagram of a computer system 100. The computer system 100 includes a CPU 102, a system memory 104 and a graphics processing system 110. The CPU 102 performs various functions, including determining information, such as a viewpoint location, which allows for the generation of graphic displays. The system memory 104 stores a variety of data, including graphic display data such as texture data 106. The graphics processing system 110, based on information determined by the CPU 102 and data stored in the system memory 104, generates display data for a display device 130, such as, for example, a monitor.

The CPU 102 provides requests to the graphics processing system 110 over a system interface 108, including requests to process and display graphics information. Graphics requests from the CPU 102 are received by the graphics processing system 110 and provided to a front end processor 112. The front end processor 112 generates a pixel stream containing pixel coordinates concomitant to the display device 130.

Information relating to the pixel coordinates generated by the front end processor 112 is provided to a texture filter 118 through a texture cache system 114. The texture filter 118 filters the information performing, for example, bilinear filtering, trilinear filtering, or a combination thereof, and generates texture data for each pixel. In addition to conventional texture filter components, such as linear interpolators and accumulators, the texture filter 118 also includes a programmable table filter for providing special filtering operations in conjunction with the other texture filter components. The texture data is a component of the final color data that is sent to a frame buffer 120, which is used to generate a display on a display device 130.

The texture cache system 114 includes multiple caches, including, for example, a level 1 (“L1”) cache and a level 2 (“L2”) cache. The texture information is stored as individual texture elements known as texels, which are used during graphics processing to define color data displayed at pixel coordinates. The texture data flows from the system memory 104 to the texture cache system 114, and then to the texture filter 118.

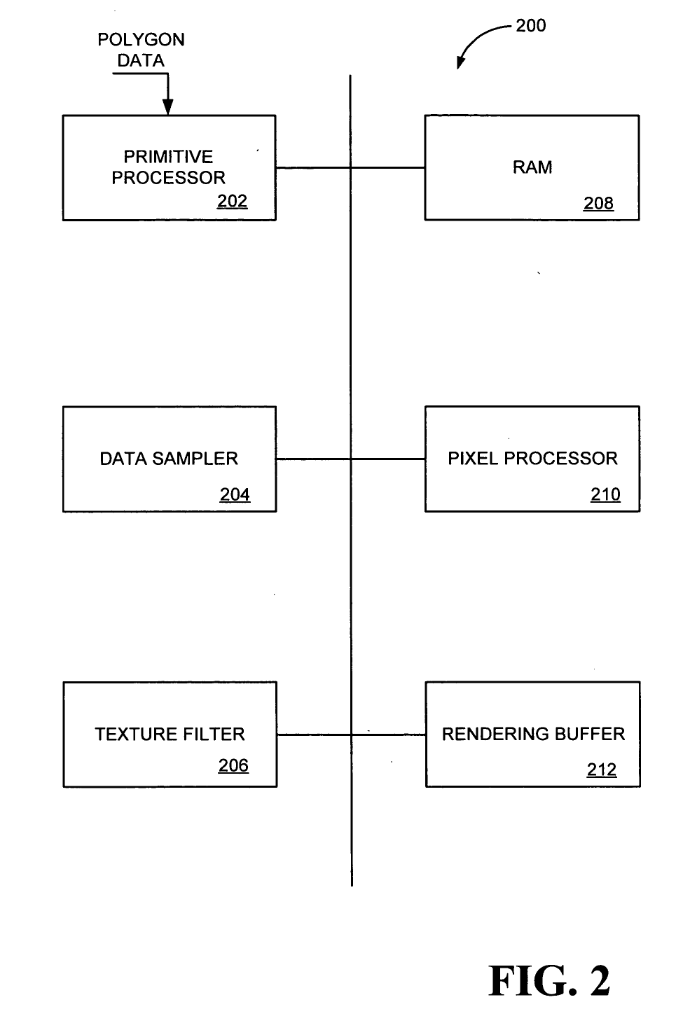

Reference is briefly made to FIG. 2, which is a block diagram illustrating an exemplary system 200 for performing texture filtering operations of the present disclosure. The exemplary system 200 is typically implemented in a graphics processing system within a computer or similar processing device. The system 200 includes a primitive processor 202, a data sampler 204, a texture filter 206, RAM 208 for storing textures, a pixel processor 210 and a rendering buffer 212.

The primitive processor 202, which may be a triangle processor, typically receives the three-dimensional geometry elements (e.g., triangles or other graphic primitives) and processes the data describing the size, shape, position, and other relative characteristics of the graphics primitives. In some cases, the primitive processor 202 is also capable of generating edge functions of the primitives. These primitives may be defined in three-dimensions using Euclidian coordinates or in four-dimensions using homogenous coordinates, and subsequently, projected onto a two-dimensional plane by a known algorithm.

The data sampler 204 selects a finite set of values from the polygon data received by the primitive processor 202. The sampling of the polygon data may occur at different resolutions. For example, interior portions of a polygon may be sampled at a rate, which is required to generate the destination screen resolution, while the detected edges of a polygon may be super-sampled at a higher resolution.

The texture filter 206 performs one or more filtering techniques using a table filter in combination with other texture filter components to calculate the color value (or other attribute) of a new texel, which is then assigned to a particular pixel. The texture filter 206 may generate the filtered textured pixel values based on data received from the RAM 208. Additionally, the texture filter 206 may be used in various types of applications such as in rendering multi-rate data samples (polygon data sampling at different resolutions).

The pixel processor 210 performs rendering operations. The rendering operations may be altered in a selected manner to generate various effects such as simulated light sources and shadows. Finally, the rendering buffer 212 stores images, which may be displayed in a display device or used to render another image.

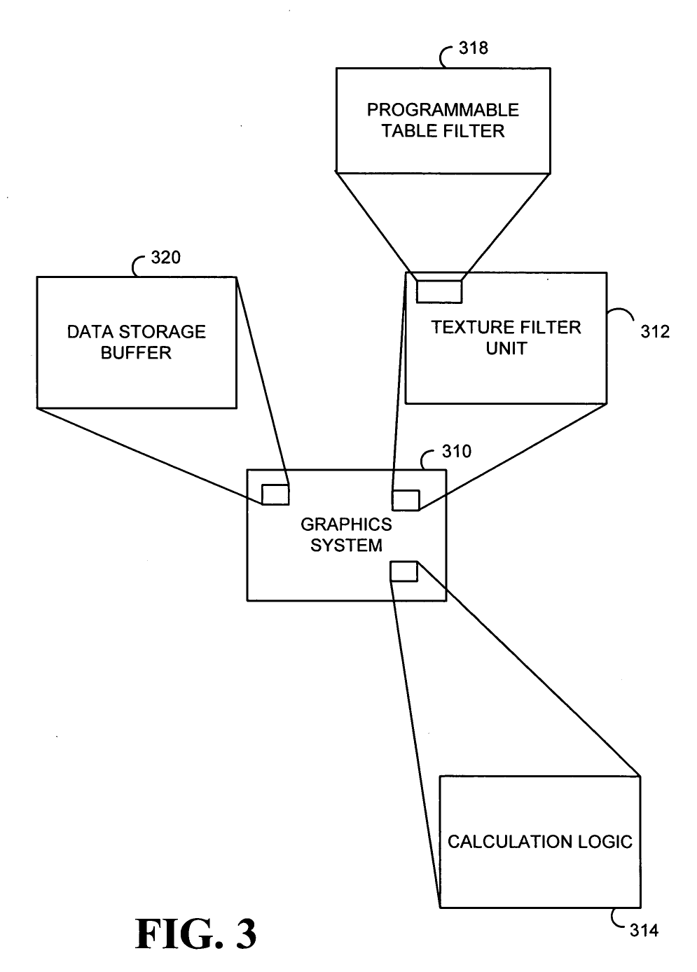

Reference is made briefly to FIG. 3, which illustrates certain basic components of a computer graphics system. The graphics system 310 includes a data storage buffer 320 that provides temporary storage for graphics data required by pending and ongoing graphics processes. Calculation logic 314 in the graphics system 310 performs intermediate and final calculations on graphics data. The calculation logic 314 may work in conjunction with or independently of the texture filter unit 312. The texture filter unit 312 performs filtering operations on texture data to provide modified or updated pixel color data. The texture filter unit 312 includes a programmable table filter 318 for improving the performance of the texture filter unit 312. The programmable table filter 318 operates in conjunction with other components of the texture filter unit 312 for, by way of example, adjusting attributes of an image to create special graphics effects.

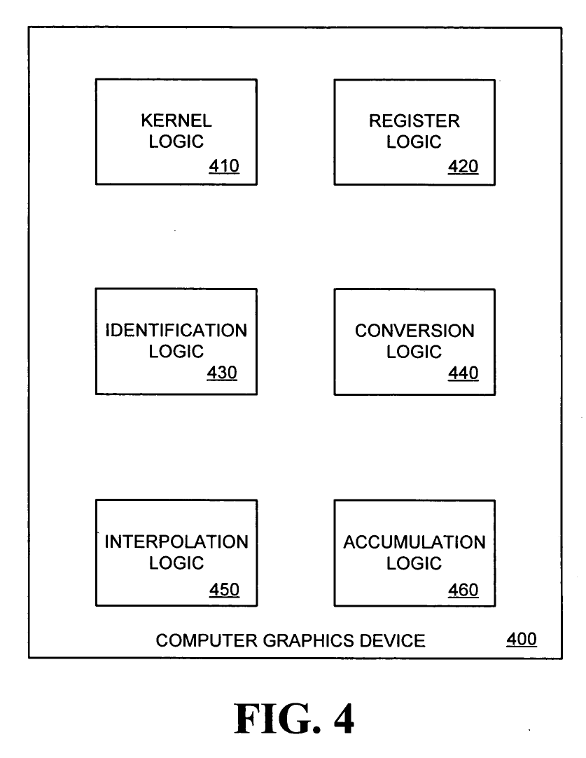

Reference is now made to FIG. 4, which is a block diagram illustrating a computer graphics device as disclosed herein. The computer graphics device 400 includes kernel logic 410 for defining the properties of a kernel. The kernel properties include, for example, the dimensional characteristics such as the width and height of the kernel. Additionally, the kernel properties include the kernel location, which is the center point of the array of texels in the kernel. The computer graphics device 400 includes register logic 420 for storing the multiple coefficients associated with the kernel. Identification logic 430 serves to identify sets of coefficient values for different kernels, such that when the kernel is selected, the coefficients can be looked up in the programmable table filter. Conversion logic 440 performs a conversion of the coefficients into blend factors for using in other texture filter components. Interpolation logic 450 may receive some or all of the blend factors and perform an interpolation as a portion of the filtering operation. Similarly, accumulation logic 460 may receive some or all of the blend factors and perform a weighted accumulation as a portion of the filtering operation.

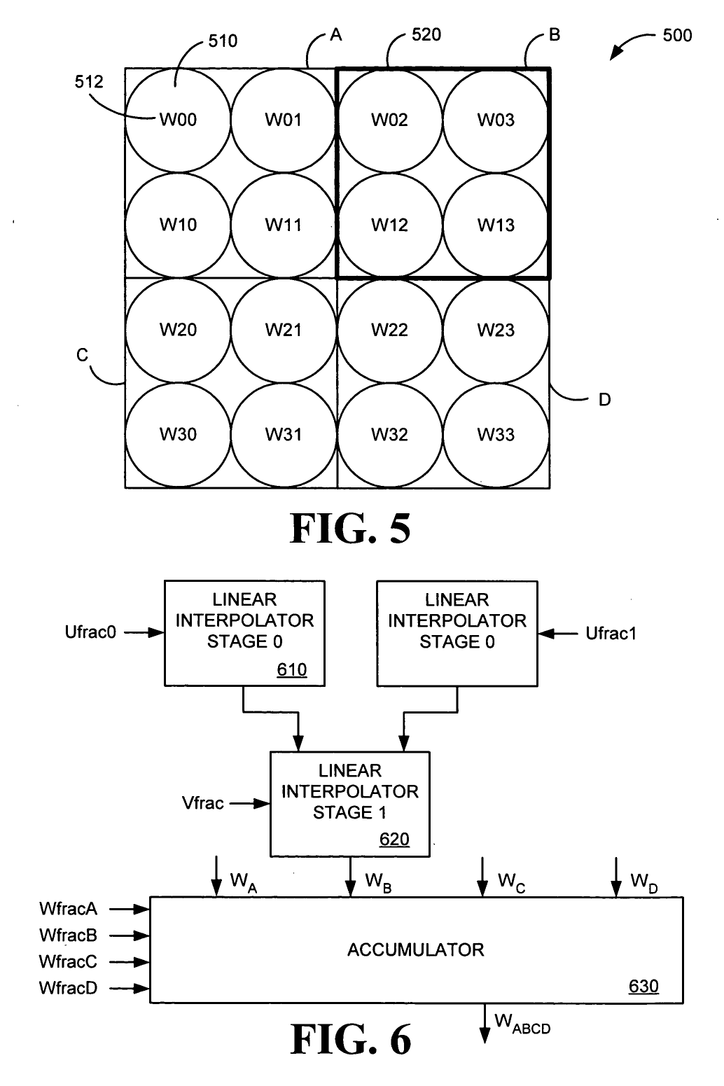

Reference is made to FIG. 5, which is a diagram of an exemplary embodiment of a general two-dimensional convolution programmable table filter kernel. The table filter kernel 500 is configured, for example, as a four by four array of texels 510. Each of the texels 510 is assigned a weight value 512, also referred to as a coefficient, such that there are sixteen weight values 512 required for this kernel configuration in a general two-dimensional convolution table filter. The weight values 512 for a specific table filter kernel 500 are stored in association with a table identifier so the filter can select the appropriate weight values 512 to lookup and load into registers. For processing purposes, in some embodiments, the table filter kernel 500 is divided into four two-by-two texel groups or sets 520.

The general two-dimensional convolution filter is defined as:

$$H [ x ] [ y ] = {\sum }_{j = 0}^{height - 1} {\sum }_{i = 0}^{width - 1} F [ x + i ] [ y + j ] G [ i ] [ j ]$$

The width and height are the dimensional properties defined by the table filter kernel 500 and the fractional portion the kernel center, F[x+i][y+j] is usually used to calculate the weight value 512 for each texel 510, G[i][j], in the table filter kernel 500. Using the weight values 512, fractional values for the linear interpolators (LRP) used in a bilinear interpolation are generated. In some embodiments, for each two-by-two texel group 520, two fractional values, Ufrac0 and Ufrac1, are calculated for the stage 0 pair of LRP's. Additionally, each two-by-two texel group will require a fractional value, Vfrac, for the stage 1 LRP and Wfrac for an accumulator. By way of example, the fractional values for the two-by-two texel group may be calculated from the weight values 512 using the following equations:
Ufrac0=W01/(W00+W01)
Ufrac1=W11/(W10+W11)
Vfrac=(W10+W11)/(W00+W01+W10+W11)
Wfrac=W00+W01+W10+W11.
Since each of the fractional values are required for each of the two-by-two texel groups 520, the four-by-four filter kernel will require 16 fractional values to be calculated and stored for use by the LRP's and accumulator.

Reference is now made to FIG. 6, which is a block diagram illustrating an embodiment of the application of table filter values to texture filter components, as disclosed herein. The table filter values, as discussed above regarding FIG. 5, serve as inputs to the LRP's and accumulator used in other texture filter modes. The fractional values Ufrac0 and Ufrac1 serve as inputs to the stage 0 LRP's 610 for interpolating the U dimension of the two-by-two texel group labeled B, in FIG. 5. The fractional value Vfrac serves as an input to the stage 1 LRP 620 for interpolating the V dimension in the B two-by-two texel group. The accumulator 630 receives, from each of the stage 1 LRP's, the data corresponding to each of the four two-by-two texel groups A, B, C, D discussed in reference to FIG. 5. Each of the data values W_{A}, W_{B}, W_{C}, and W_{D} received from the LRP's is multiplied with the corresponding fractional value Wfrac that is generated for that two-by-two texel group. The accumulator 630 adds the resulting products to generate a composite weight value W_{ABCD}.

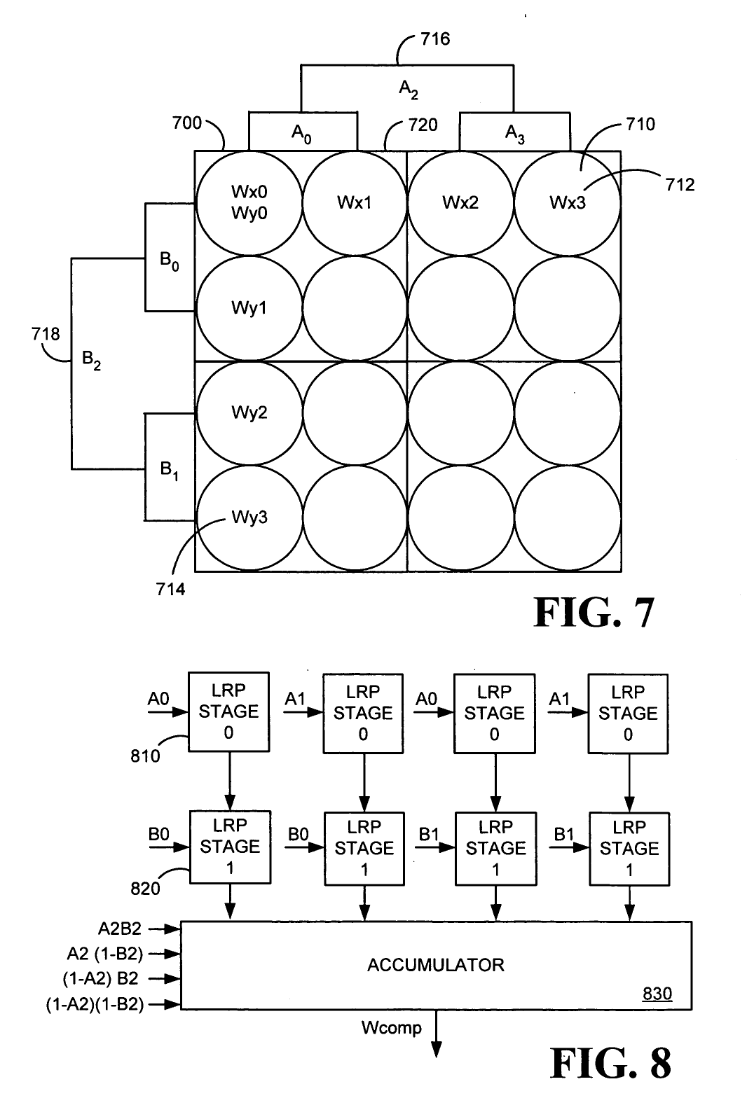

Reference is now made to FIG. 7, which is a diagram of an exemplary embodiment of a separable two-dimensional convolution programmable table filter kernel. The table filter kernel 700 is configured, for example, as a four by four array of texels 710. Each of the texels 710 has a weight value having a component in a first dimension 712 and a component in a second dimension 714. For example, each of the sixteen texels 710 in the separable two-dimensional scheme shown in FIG. 7 can be expressed using an ordered pair combination from the eight components 712, 714. The weight value components 712, 714 for a specific table filter kernel 700 are stored associated with a table identifier so the filter can select the appropriate weight value components 712, 714 to lookup and load into registers. The X dimensional weight value components 712 are represented by the variables Wx0, Wx1, Wx2, and Wx3 such that each variable represents the X value for all texels 710 in the corresponding column. Similarly, the Y dimensional weight value components 714 are represented by the variables Wy0, Wy1, Wy2, and Wy3 such that each variable represents the Y value for all texels 710 in the corresponding row.

The separable two-dimensional convolution filter weights, or coefficients, can be expressed in terms of two vectors:
G_{row}[0 . . . (width−1)] G_{col}[0 . . . (height−1)]
The convolution operation on the separable filter may be performed using only (width+height) multiplications for each output pixel. Application of the separable filter to the general convolution filter results, after simplification, in the equation:
G[0 . . . (width−1)] [0 . . . (height−1)]
To apply the separable convolution, first apply G_{row} while setting the height to 1 and then apply G_{col} while setting the width to 1.

The width and height are the dimensional properties defined by the table filter kernel 700. Using the eight weight value components 712, 714, a set of three blend factors 716, 718 corresponding to each of the two kernel dimensions. The X dimension blend factors 716 include A0, A1, and A2 and the Y dimension blend factors 718 include B0, B1, and B2. Based on the conditions that each of the weight value components 712, 714 is in the range [0,1],
Wx0+Wx1+Wx2+Wx3=1 and
Wy0+Wy1+Wy2+Wy3=1,
the blend factors are determined from the weight value components by the equations:
A0=Wx1/(Wx0+Wx1)
A1=Wx3/(Wx2+Wx3)
A2=Wx0+Wx1
B0=Wy1/(Wy0+Wy1)
B1=Wy3/(Wy2+Wy3)
B2=Wy0+Wy1.
The blend factors 716, 718 are used as the fractional values for the LRP's for each of the two-by-two texel groups 720.

Reference is now made to FIG. 8, which is a block diagram illustrating an embodiment of the application of separable table filter values to texture filter components, as discussed above in reference to FIG. 7. Unlike the generalized convolution filter, the separable convolution filter requires only a single stage 0 LRP 810 for each two-by-two texel group. For example, the stage 0 LRP 810 for the top-left two-by-two texel group of the kernel will utilize the A0 value for a Ufrac value. The stage 1 LRP 820 for the same texel group will utilize the B0 value for a Vfrac value. The stage 0 LRP's 810 for all four of the two-by-two texel groups will use either A0 or A1 for a Ufrac value. Similarly, the stage 1 LRP's for all four of the two-by-two texel groups will use either B0 or B1 for a Vfrac value. The four Wfrac values used for weighting the four corresponding inputs to the accumulator 830 are determined by the A2 and B2 values. The expressions for the four two-by-two texel groups are shown in the following table:

| Top Left | Top Right | Bottom Left | Bottom Right |
|---|---|---|---|
| 2 × 2 | 2 × 2 | 2 × 2 | 2 × 2 |
| A2 B2 | A2 (1 − B2) | (1 − A2) B2 | (1 − A2)(1 − B2) |

In contrast with the general convolution filter, the separable convolution filter requires the storage of only eight weights, or coefficients, and six blend factors for a four-by-four kernel. One of ordinary skill in the art knows or will know that the four-by-four kernel size and the two-by-two texel groups are merely exemplary and not intended to limit the scope or spirit of the disclosure in any way.

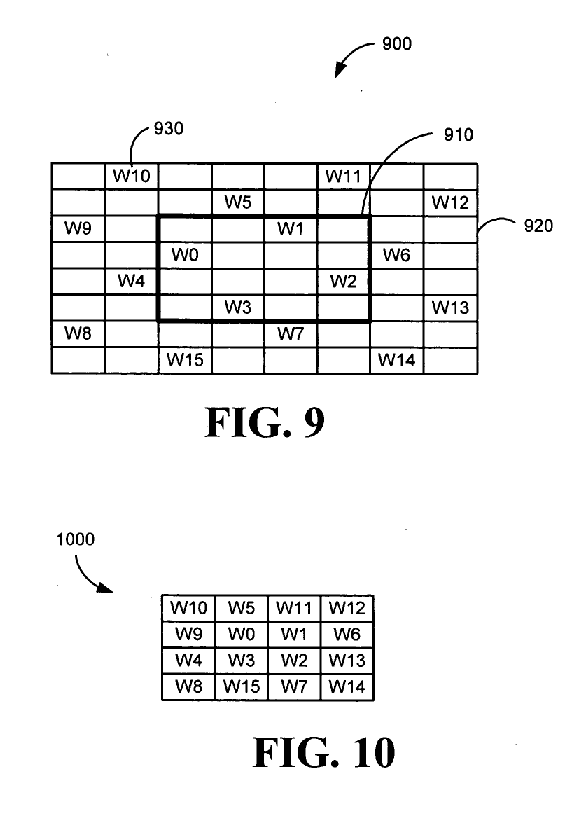

Reference is now made to FIG. 9, which is a block diagram illustrating a table filter kernel configured for multi-sample anti-aliasing (MSAA) down filtering. The MSAA rendering generates a higher resolution render target by providing multiple samples for each texel. The programmable table filter logic down-samples the higher resolution MSAA data to the original size by setting weights to the samples in the table filter. For example, in the case of an MSAA system utilizing a sampling rate of four, the samples, or subpixels, are rendered in a high resolution buffer in the pattern illustrated by the location of the weights 930. The sampling rate of four determines that there are four subpixels for each texel. To calculate the final pixel value, the surrounding subpixels are selected and filtered. The four-by-four filter kernel 910 is extended to the neighboring eight-by-eight kernel 920 to include the all of the MSAA subpixels. Since the locations of the subpixels are not symmetrical, each subpixel has a weight calculated based on the distance from the subpixel to the center of the pixel. The subpixels further from the pixel have a lower weight 930 than those closer to the pixel and the sum of all of the weights 930 equals one. The final pixel value is generated by the expression:

$$P = {\sum }_{i = 0}^{\# SubPixels - 1} W [ i ] - SubPixel [ i ]$$

Each of the subpixels requires the storage of one weight for the filter kernel. For example, a four-by-four facilitates the storage of sixteen weights in the table to perform the programmable table filter operation.

Reference is now made to FIG. 10, which is a block diagram illustrating the actual storage configuration of the MSAA down-sampling filter referenced in FIG. 9. Unlike the kernel of FIG. 9, which illustrates the subpixels in the high-resolution buffer, the subpixels are stored in a packed format, as shown in the four-by-four filter kernel 1000. The subpixels can be fetched in two-by-two units and processed using similar methods as the general convolution operation discussed above in reference to FIGS. 5 and 6. In MSAA mode, only one set of weights is required and the number of weights in that set is equal to the kernel size, which is defined by the real number of subpixels inside the kernel. In an embodiment, the programmable table filter can process two two-by-two texels groups per cycle. The number of cycles is thus determined by the MSAA mode and the kernel size. For example, in an operation with an MSAA sampling rate of two and a kernel size of four-by-two, the filter operation can be performed in one cycle. Alternatively, a sampling rate of four and a four-by-four kernel will require two cycles to complete the filter operation.

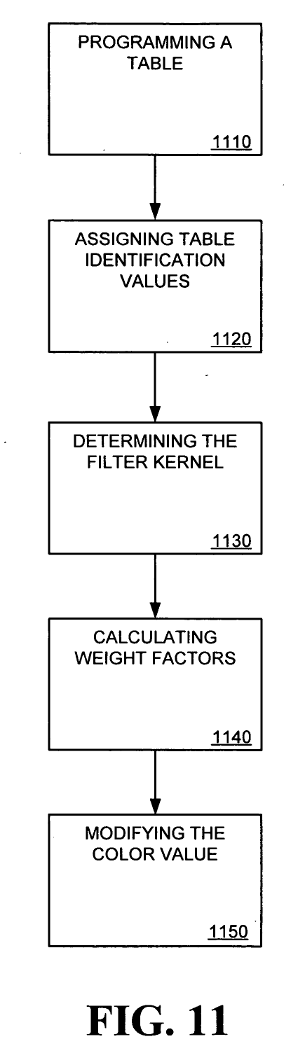

Reference is now made to FIG. 11, which is a block diagram illustrating an embodiment of a method of filtering texture data using a programmable table filter, as disclosed herein. Texture filter data is programmed into a programmable table filter in block 1110. The flexible nature of the programmable table filter permits different coefficient values to be utilized to perform special visual effects, such as, for example, spotlighting. Identification values are assigned to the table in block 1120 so that the filter table coefficients can be accessed from a storage location. A filter kernel is determined in block 1130 to define the kernel dimensional characteristics. Weight factors are calculated in block 1140 to be used as inputs to conventional filter components such as linear interpolators and accumulators. A pixel color value is modified using a composite output from the filter components in block 1150.

The embodiments of the present disclosure can be implemented in hardware, software, firmware, or a combination thereof. In some embodiments, the methods and systems are implemented in software or firmware that is stored in a memory and that is executed by a suitable instruction execution system. If implemented in hardware, as in an alternative embodiment, the methods and systems can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code, which include one or more executable instructions for implementing specific logical functions or steps in the process, and alternate implementations are included within the scope of an embodiment of the present disclosure in which functions may be executed out of order from that shown or discussed, including substantially concurrently or in reverse order, depending on the functionality involved, as would be understood by those reasonably skilled in the art of the present disclosure.

The methods and systems herein, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. In addition, the scope of the present disclosure includes embodying the functionality of embodiments of the present disclosure in logic embodied in hardware or software-configured mediums.

It should be emphasized that the above-described embodiments of the present disclosure, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

The following is claimed:

1. A method of filtering computer graphics texture data, comprising:
programming a table with texture filter data;
assigning a plurality of table identification values;
determining a filter kernel, configured as a texel array including a plurality of texels, corresponding to a location of a pixel;
calculating a plurality of weight factors from a portion of the texture filter data, corresponding to the filter kernel; and
modifying a pixel color value, corresponding to the pixel, using the plurality of weight factors.

2. The method of claim 1, wherein the programming comprises determining the plurality of texel coefficients for each of the plurality of texels in the filter kernel.

3. The method of claim 2, wherein one of the plurality of table identification values corresponds to the filter kernel.

4. The method of claim 3, wherein the programming further comprises storing the plurality of texel coefficients in a register, corresponding to one of the plurality of table identification values.

5. The method of claim 1, wherein the programming comprises determining a plurality of texel coefficient row components and a plurality of texel coefficient column components for the texel array.

6. The method of claim 5, wherein the programming further comprises determining each of the plurality of texel coefficients utilizing a combination of the plurality of texel coefficient row components and the plurality of texel coefficient column components.

7. The method of claim 5, wherein the texel array comprises N rows and wherein each row corresponds to one of the plurality of texel coefficient row components.

8. The method of claim 7, wherein the texel array comprises M columns and wherein each column corresponds to one of the plurality of texel coefficient column components.

9. The method of claim 8, wherein the calculating comprises:
generating a first set of blend factors from the plurality of texel coefficient row components; and
generating a second set of blend factors from the plurality of texel coefficient column components.

10. The method of claim 9, wherein the calculating further comprises utilizing the first set of blend factors and the second set of blend factors as linear interpolation unit input factors.

11. The method of claim 9, wherein the calculating further comprises utilizing the first set of blend factors and the second set of blend factors as accumulator input factors.

12. A computer graphics processing apparatus comprising:
kernel logic configured to define a plurality of texels having a plurality of kernel dimensional characteristics;
register logic configured to store a plurality of coefficients for a kernel;
identification logic configured to assign a table identification value to the kernel;
conversion logic configured to generate a plurality of blend factors;
interpolation logic configured to receive a portion of the plurality of blend factors; and
accumulation logic configured to receive a portion of the plurality of blend factors.

13. The apparatus of claim 12, wherein the plurality of kernel dimensional characteristics comprise a width and a height.

14. The apparatus of claim 13, wherein the width equals four texels and the height equals four texels.

15. The apparatus of claim 13, wherein the conversion logic comprises subdividing the kernel into a plurality of two-by-two texel sets.

16. The apparatus of claim 15, wherein the conversion logic further comprises:
first blending logic configured to generate, for each of the plurality of two-by-two texel sets, two of the plurality of blend factors corresponding to a first dimension;
second blending logic configured to generate, for each of the plurality of two-by-two texel sets, one of the plurality of blend factors corresponding to a second dimension; and
third blending logic configured to generate, for each of the plurality of two-by-two texel sets, one of the plurality of blend factors corresponding to a third dimension.

17. The apparatus of claim 16, wherein the interpolation logic comprises input logic configured to receive the ones of the plurality of blend factors corresponding to the first dimension and the second dimension.

18. The apparatus of claim 16, wherein the accumulation logic comprises input logic configured to receive the ones of the plurality of blend factors corresponding to the third dimension.

19. The apparatus of claim 12, further comprising storing logic for storing the plurality of blend factors in a lookup table corresponding to the table identification value.

20. The apparatus of claim 12, wherein the plurality of coefficients comprises a plurality of row components and a plurality of column components.

21. The apparatus of claim 14, wherein the conversion logic comprises blending logic configured to generate the plurality of blend factors from the plurality of row components and the plurality of column components.

22. The apparatus of claim 21, wherein the conversion logic further comprises partitioning logic configured to subdivide the kernel into a plurality of two-by-two texel groups.

23. The apparatus of claim 22, wherein a first set of the plurality of blend factors corresponds to a first axis of the kernel and wherein a second set of the plurality of blend factors corresponds to a second axis of the kernel.

24. The apparatus of claim 23, wherein the interpolation logic comprises:
a first linear interpolator configured to receive one of the first set of the plurality of blend factors; and
a second linear interpolator configured to receive one of the second set of the plurality of blend factors.

25. The apparatus of claim 23, wherein the accumulation logic comprises an accumulator configured to receive a plurality of weight factors.

26. The apparatus of claim 25, wherein the plurality of weight factors are determined by the first set of the plurality of blend factors and the second set of the plurality of blend factors.

27. A system for filtering computer graphics data, comprising:
a data storage buffer adapted to store multiple sample anti-aliasing color data;
calculation logic configured to determine a plurality of weight values for the multiple sample anti-aliasing color data;
a programmable table filter configured to store the plurality of weight values; and
texture filter logic configured to modify a pixel color value based on the plurality of weight values.

28. The system of claim 27, wherein the multiple sample anti-aliasing color data comprises a plurality of subpixels.

29. The system of claim 28, wherein the programmable table filter comprises an adaptable kernel, having a fixed center point, configured to provide a plurality of adjustable dimensional properties.

30. The system of claim 29, wherein the plurality of adjustable dimensional properties are configured to receive all of the plurality of subpixels of a set of pixels.

31. The system of claim 30, wherein each of the plurality of weight values corresponds to one of the plurality of subpixels;
wherein each of the plurality of weight values is a fractional value determined by a location relative to the center point; and
wherein a sum of the plurality of weight values equals 1.

32. The system of claim 31, further comprising a means for storing the plurality of weight values in the programmable table filter in a packed format.

33. The system of claim 29, wherein the plurality of adjustable dimensional properties are determined by a sampling rate of the multiple sample anti-aliasing color data.

34. The system of claim 27, comprising conversion logic configured to generate a plurality of blend factors.

35. The system of claim 34, comprising interpolation logic configured to receive a first subset of the plurality of blend factors.

36. The system of claim 35, comprising accumulation logic configured to receive a second subset of the plurality of blend factors.

37. The system of claim 27, further comprising means for identifying the plurality of weight values for the programmable table filter.
